(19) United States
(12) Patent Application Publication
(10) Pub. No.: US 2006/0181987 A1
(43) Pub. Date: Aug. 17, 2006

(54) Method and apparatus for determining the optimal laser power in recordable optical storage systems

(75) Inventors: Gerardus Rudolph Langereis, Eindhoven (NL); Joachim Wilhelm Hellmig, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/562,275

(22) PCT Filed: Jun. 22, 2005
(86) PCT No.: PCT/IB04/50970

§ 371 Date: Dec. 22, 2005

(30) Foreign Application Priority Data
Jun. 26, 2003 (EP) 03101902.9

(51) Int. Cl. G11B 7/00; G11B 5/09

(52) U.S. Cl. 369/47.53; 369/47.5; 369/53.18

(57) ABSTRACT

The invention relates to a method of reducing the area on an optical medium used by an optimum write parameter control procedure (OPC) and to an apparatus for carrying out the method. The method makes use of a reference data pattern written using a reference set of write parameters, and a measurement data pattern written using a measurement set of write parameters.

The present invention relates generally to recordable optical storage systems, and more specifically to the determination of an optimal laser power for use with recordable optical storage systems and optical storage discs.

As is well known, optical storage media, such as for example CD and DVD recordable and rewritable discs, are made up of an optical stack. The stack commonly consists of polycarbonate substrate, a sensitive dye layer, a gold or silver alloy reflector and a protective lacquer coating. Data is written to a disc by focusing a high power radiation beam, such as a laser beam, onto the dye layer so as to heat an area such that the reflectivity of the area is altered. The areas form a spiral track of variable length marks (low reflective areas), and lands (highly reflective areas between the marks). The resulting pattern of the marks and lands encodes the data to be stored on the disc. Each transition between a mark area and a land area corresponds to the physical encoding of a data “1” value. The marks and spaces are generally encoded using a run length limited code resulting in a fixed set of lengths. For example, lengths of 3T to 14T for DVD (where ‘T’ represents one period of a data clock).

Precise mark length is critical if data is to be represented accurately. For example, if an optical reader reads a disc with a number of 3T marks or lands that are too long, these could be misinterpreted as 4T features. This misinterpretation may result in incorrect data retrieval, and, in extreme cases, read-failure.

For this reason, it is essential that optical recorders are able to monitor and maintain the quality of disc writing in order to ensure the accuracy of all the mark and land lengths over the particular disc being written.

In order to achieve accurate writing, the write power should be optimized. In addition, optimizing the write pulse shape results in reduction of read-out errors. Optimizing the write pulse shape results in minimized recording jitter. Jitter is a statistical measurement of the variation in mark to space or space to mark transitions occurring when a disc is read.

Two different optimal power control procedures (OPC) are currently in use for Recordable (R), and ReWriteable (RW) optical storage discs. For R-discs ‘beta’ and ‘jitter’ (or ‘sigma’) OPC methods are used, whilst for RW-discs a ‘Gamma’ method is generally used as the OPC procedure.

These presently used OPC methods are based upon information being used, which information is pre-stored on the disc. For example, information may be pre-stored onto a disc that provides a recorder with an indicative power level with which to begin an OPC procedure. This information may not, however, always be correct, and can result in OPC failure.

Currently, a jitter measure is used in the DVD+R(W) data recorders and video recorders. This is done in the so-called jitter OPC or σ-OPC to find the write power at which the system margins (with respect to jitter) are the largest. This conventional σ-OPC consists of the consecutive writing of a number of tracks at increasing write powers. The result is a jitter versus write power plot which generally has a U-shape.

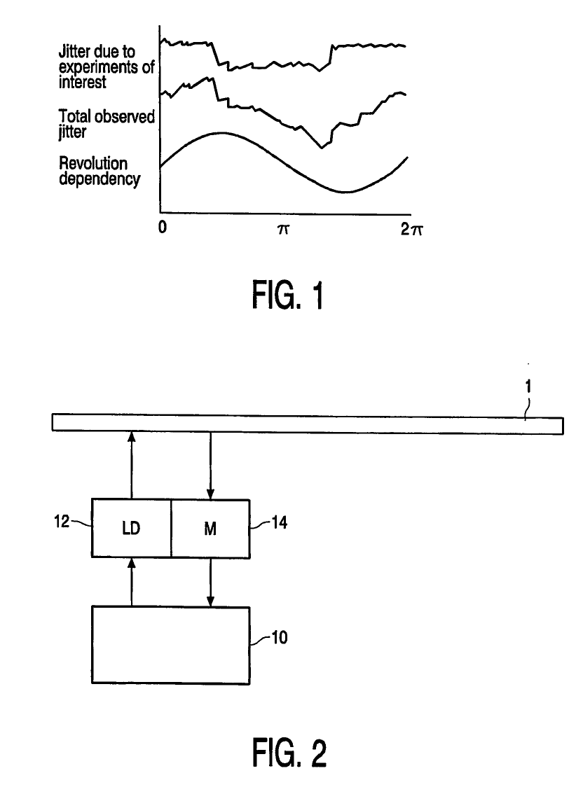

However, the observed jitter is not only the result of the applied write power. Variations of jitter due to inhomogeneities of the disc affect the measurement as well. This is illustrated in FIG. 1.

It is known from experience with such discs that jitter due to the location on the disc is dependent on the tangential position, rather than the radial position within a specific range. To eliminate fluctuations on the jitter measurements, it is sufficient to eliminate rotational variations.

Therefore, conventionally jitter is averaged over a complete revolution of the disc. This means that, for example, ten jitter measurements take ten revolutions. This is a significant part of the available power calibration area of the disc.

There is therefore a need for a space efficient write pulse calibration method.

According to a first aspect of the present invention there is provided a method of determining an optimum set of write parameters for a laser device for writing to an optical storage medium, the method comprising:

defining a test region of the optical storage medium;

using a laser device having an operating set of write parameters, writing a predetermined data pattern to the test region;

measuring jitter values for the predetermined data pattern; and selecting an optimum operating set of write parameters of the laser device for writing data to the optical storage medium in dependence upon the measured jitter values, the optimum set of write parameters minimizing the jitter value for the optical storage medium,

characterized in that the step of writing a predetermined data pattern to the test region comprises the steps of:

writing a reference data pattern using a reference set of write parameters of the laser device to the test region; and writing a measurement data pattern to the test region using a measurement set of write parameters of the laser device.

According to another aspect of the present invention, there is provided an apparatus for determining an optimum set of write parameters for a laser device for writing to an optical storage medium having a test region defined thereon, the apparatus comprising:

an optical writing device operable to write a predetermined data pattern to a test region of an optical medium at an operating set of write parameters;

a measurement device operable to measure jitter values for a predetermined data pattern on an optical medium; and

a power controller operable to select an optimum operating set of write parameters of the laser device for writing data to the optical storage medium in dependence upon measured jitter values, the optimum set of write parameters minimizing the jitter value for the optical storage medium,

characterized in that the optical writing device is operable to:

write a reference data pattern at a reference set of write parameters to the test region; and write a measurement data pattern to the test region at a measurement set of write parameters.

These and other objects, features and advantages of the invention will be apparent from the following more particular description as illustrated in the accompanying drawings, where

FIG. 1 illustrates jitter measurements,

FIG. 2 is a block diagram illustrating an apparatus embodying one aspect of the present invention,

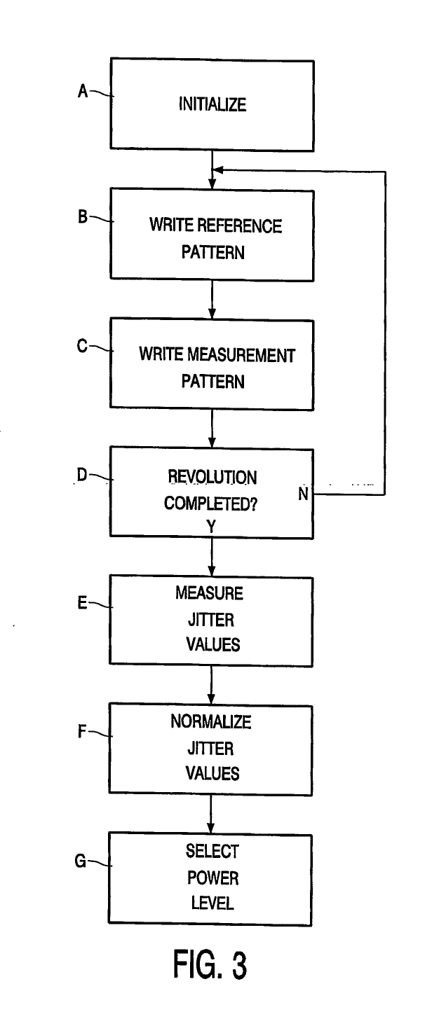

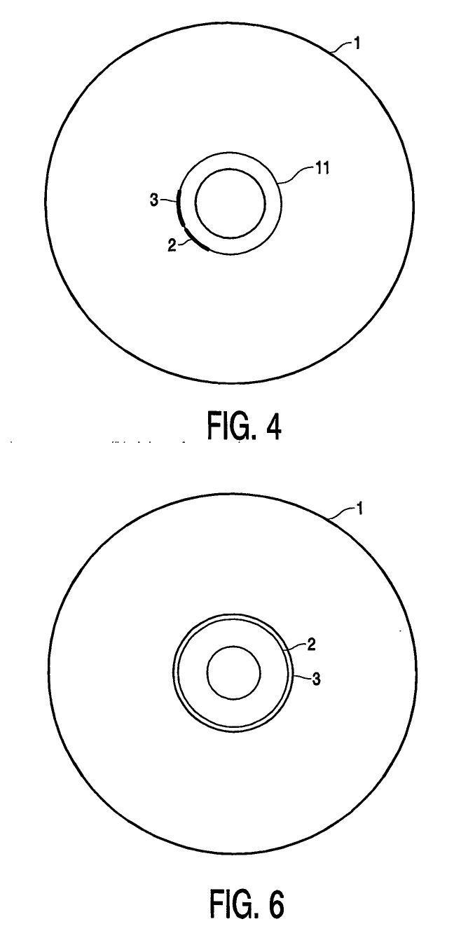

FIG. 3 and FIG. 4 illustrate a first embodiment of the present invention, and

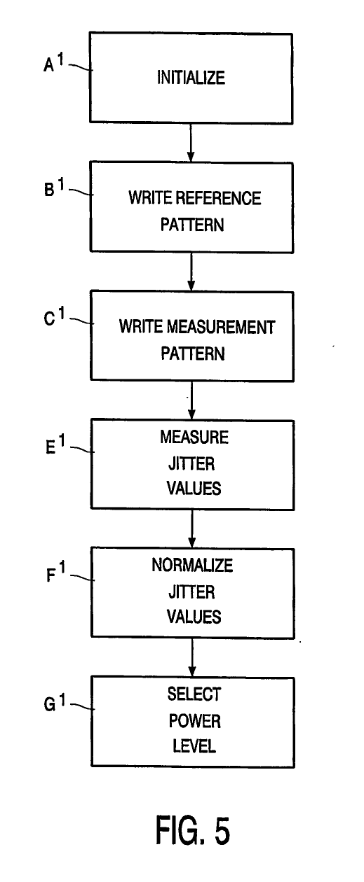

FIG. 5 and FIG. 6 illustrate a second embodiment of the present invention.

FIG. 2 of the accompanying drawings illustrates schematically an apparatus embodying the present invention. A disc 1 is held and rotated in a known manner by a known disc drive apparatus, which is not shown for the sake of clarity.

A controller 10 is provided for controlling output parameters of a laser device 12, which is used to read and write from and to the disc 1. The parameters that can be controlled by the controller 10 include write power level, write pulse edges and overpowers. A measurement device 14 is provided for measuring jitter values and for supplying data relating to those measurements to the power controller 10. The operation of the apparatus of FIG. 2 will be described in more detail below.

In order to determine an optimum set of write parameters, that is, a set of parameters that leads to a minimum level of jitter, the minimum jitter value needs to be found. Due to the definition of jitter as the standard deviation of noise in mark edges, jitter values from different sources can be combined as follows:
(Jitterₜₒₜₐₗ)²=(Jitter_{source1})²+(Jitter_{source2})² (1)
where jitterₜₒₜₐₗ is the total jitter value, jitter_{source1} is the jitter attributed to a first source and jitter_{source2} is the jitter attributed to a second source. The present invention makes use of this relationship, and operates to combine jitter values from reference values and measurement values.

FIG. 3 is a flow diagram illustrating a first method embodying the present invention, and FIG. 4 illustrates a test data pattern written to a disc 1 using the method of FIG. 2.

Following initialization at step A, the first method writes a reference data pattern 2 using a reference set of write parameters (step B). For example, the reference set of parameters can include a fixed write power of the laser device, and fixed write pre-compensation. The reference data pattern 2 is written to a part of a track 11 of the disc 1. A measurement data pattern 3 is then written to the disc 1, in the same track 11 as the reference data pattern (step C). The measurement data pattern 3 is written using a measurement set of write parameters, which can vary from that used for the reference pattern. For example, the write power of the laser source can be varied.

The writing of alternate reference and measurement data patterns 2 and 3 continues until a revolution of the disc 1 is completed. When the set of reference and measurement data patterns 2 and 3 have been written to the disc, the method then measures jitter values for the various patterns (step E), normalizes those values (step F, described below), and then selects the optimum set of write parameters on the basis of the normalized jitter values.

Since there is always just a small angular difference between two consecutively written sequences, it is sufficiently accurate to normalize consecutive reference and measurement jitter values using equation (1).

The equation becomes

$${jitter}_{norm} = \pm \sqrt{\vert {( {jitter}_{meas} )}^{2} - {( {jitter}_{ref} )}^{2} \vert} \qquad ( 2 )$$

where jitterₙₒᵣₘ is the normalized jitter of interest (that is, the jitter sources from equation 1), jitterₘₑₐₛ is the jitter of the measurement data pattern, and jitter_{ref} is the jitter of the reference data pattern (source 2 of equation 1). Note that the sign must be explicitly regenerated because the jitter on the measurement pattern of interest might be either higher or lower than the jitter on the reference pattern. The sign is dependent upon the relative sizes of jitterₘₑₐₛ and jitter_{ref}.

The optimum power level is then selected on the basis of the minimum normalized jitter value, determined by equation (2). Alternatively, the jitter value can be normalized using the equation
jitterₙₒᵣₘ=jitterₘₑₐₛ−jitter_{ref} (3)
which is sufficiently accurate of a small practical range of observed jitter. With a simplified normalization formula, the chance of the propagation of errors is reduced.

In one example, the measurement power level varies during writing of the measurement data pattern. In the embodiment of FIGS. 3 and 4, each measurement pattern portion has a specific measurement power level, and these power levels increase in a stepwise manner from a minimum level to a maximum level. Alternatively, the measurement power level can be varied continuously.

However, in method of FIGS. 3 and 4, there is always a small angular difference between the reference pattern and the measurement pattern. The jitter fluctuations in a tangential direction are typically higher than from track to track in a radial direction. Accordingly, in a second method embodying the present invention, a reference pattern is written to the disc on one revolution on one track of the disc, and a measurement pattern is written on a different track of the disc on a second revolution. This second method is illustrated in FIGS. 5 and 6. This method makes use of the fact that jitter fluctuations are dependent on the tangential position and not the radial position (on a small scale). In the second embodiment, the reference data pattern is written (step B′) using a reference set of write parameters (e.g. fixed power level), and a measurement set of parameters (e.g. varying power level) is used during writing (step C′) of the measurement data pattern. The measurement data patterns 3 and reference data patterns 2 are written in neighboring tracks of the disc, as is shown in FIG. 6.

In order that the normalization is valid, it is preferred to uses radially aligned jitter measurements for the measurement and reference data patterns. In an optical disc drive, this is achieved using the defined timing pattern, known as the “wobble”. At radius R, the neighboring sequence is found after 2πR/w wobble counts, with w the wobble length. A small mismatch, however, will not be a problem.

Besides the currently implemented σ-OPC, the above-described jitter evaluations can be used for other write parameter optimization (see, for example European Patent Application 02077527.6-PHNL020578—by the same inventor). In such a case, it is not simply the write power that is ramped, but other write strategy parameters (such as, for example, write pulse edges and overpowers) as well. The response is a second order curve, which can be reduced to a first order problem by subtracting a reference measurement. The subtracted jitter can be referred to as “ΔJ”. To normalize:
ΔJ=jitterₘₑₐₛ−jitter_{ref} (4)
This means that the idea of using jitter measurements on reference sequences can directly be applied to the mentioned write strategy optimization algorithm.

It will be appreciated that embodiments of the present invention provide methods and apparatus for measuring jitter values, and then selecting an optimum set of write parameters, using a greatly reducing disc area. It will also be appreciated that the principles of the present invention can be applied to other optical media, apart from discs, and that laser device includes any device producing radiation, either within or without the visible spectrum.

Examples of disc type optical recording medium to be used in combination with the present invention include CD, CD-R, CD-RW, DVD-R, DVD-RW, DVD-R-Dual-Layer, DVD-RW-Dual-Layer, DVD+R, DVD+RW, DVD+R-Dual-Layer, DVD+RW-Dual-Layer, DVD-RAM, and Blu-ray Disc discs.

1. A method of determining an optimum set of write parameters for a laser device for writing to an optical storage medium, the method comprising:
defining a test region of the optical storage medium;
using a laser device having an operating set of write parameters, writing a predetermined data pattern to the test region;
measuring jitter values for the predetermined data pattern; and
selecting an optimum operating set of write parameters of the laser device for writing data to the optical storage medium in dependence upon the measured jitter values, the optimum set of write parameters minimizing the jitter value for the optical storage medium,
characterized in that the step of writing a predetermined data pattern to the test region comprises the steps of:
writing a reference data pattern using a reference set of write parameters of the laser device to the test region; and
writing a measurement data pattern using a measurement set of write parameters of the laser device to the test region.

2. A method as claimed in claim 1, wherein each set of write parameters includes a power level of the laser device.

3. A method as claimed in claim 2, wherein the power level of the laser device varies over the writing of the measurement data pattern.

4. A method as claimed in claim 3, wherein the power level of the laser device rises from a minimum level to a maximum level over the writing of the measurement data pattern.

5. A method as claimed in claim 4, wherein the power level of the laser device rises in discrete steps over the writing of the measurement data pattern.

6. A method as claimed in any one of claim 2, wherein the power level of the laser device over the writing of the reference data pattern is fixed.

7. A method as claimed in claim 1, wherein the measured jitter values relate to an average of jitter values of the measurement and reference data patterns.

8. A method as claimed in claim 1, wherein the optical medium is a disc, and wherein the reference and measurement data patterns form an alternating pattern on a single track of the disc.

9. A method as claimed in claim 1, wherein the optical medium is a disc, and wherein the reference and measurement data patterns are written on consecutive tracks of the disc.

10. A method as claimed in claim 1, wherein the optical medium is a disc, and wherein the reference and measurement data patterns are written on neighbouring tracks of the disc.

11. Apparatus for determining an optimum power level for a laser device for writing to an optical storage medium (1) having a test region defined thereon, the apparatus comprising:
an optical writing device (12) operable to write a predetermined data pattern (2,3) to a test region of an optical medium (1) using an operating set of write parameters;
a measurement device (14) operable to measure jitter values for a predetermined data pattern (2,3) on an optical medium (1); and
a power controller (10) operable to select an optimum operating set of write parameters of the laser device (12) for writing data to the optical storage medium (1) in dependence upon measured jitter values, the optimum set of write parameters minimizing the jitter value for the optical storage medium (1),
characterized in that the optical writing is operable to:
write a reference data pattern using a reference set of write parameters to the test region; and
write a measurement data pattern using a measurement set of write parameters to the test region.

12. Apparatus as claimed in claim 11, wherein each set of write parameters includes a power level of the laser device.

13. Apparatus as claimed in claim 12, wherein the optical writing device (14) is operable to vary the power level of the laser device during writing of the measurement data pattern.

14. Apparatus as claimed in claim 13, wherein the power level of the laser device rises from a minimum level to a maximum level over the writing of the measurement data pattern.

15. Apparatus as claimed in claim 14, wherein the power level of the laser device rises in discrete steps.

16. Apparatus as claimed in any one of the claims 12, wherein the power level of the laser device over the writing of the reference data pattern is fixed.

17. Apparatus as claimed in claim 11, wherein the measured jitter values relate to an average of jitter values of the measurement and reference data patterns.

18. Apparatus as claimed in claim 11, wherein the optical medium is a disc, and wherein the reference and measurement data patterns form an alternating pattern on a single track of the disc.

19. Apparatus as claimed in claim 11, wherein the optical medium is a disc, and wherein the reference and measurement data patterns form are written on consecutive tracks of the disc.

20. Apparatus as claimed in claim 11, wherein the optical medium is a disc, and wherein the reference and measurement data patterns are written on neighboring tracks of the disc.
